(19) United States
(12) Patent Application Publication
(10) Pub. No.: US 2018/0332102 A1
(43) Pub. Date: Nov. 15, 2018

(54) CLOUD-BASED SYSTEM FOR COLLABORATING ENGINEERING, OPERATIONS, MAINTENANCE, PROJECT MANAGEMENT, PROCUREMENT AND VENDOR DATA AND ACTIVITIES

(71) Applicant: Michael Sheidaei, Katy, TX (US)

(72) Inventor: Michael Sheidaei, Katy, TX (US)

(21) Appl. No.: 16/036,217

(22) Filed: Jul. 16, 2018

Related U.S. Application Data
(60) Provisional application No. 62/646,644, filed on Mar. 22, 2018.

(51) Int. Cl. H04L 29/08; G06N 5/02

(52) U.S. Cl. CPC H04L 67/10; G06N 5/022

(57) ABSTRACT

A cloud-based system and methods for directly collaborating activities of one or more department including engineering, operations, maintenance, construction, project management, procurement, vendor and contractor via a cloud platform utilizing Artificial Intelligence (AI), is disclosed. The system is configured to connect with a computerized application to store and manage data and activities of one or more department. The system enables vendors to access the data of one more department to perform vendor activities such as generating quote documents. The system further configured to provide a bid evaluation including a list of one or more vendor comprising products matching the requirement of the one or more department. The system further enables personnel of one or more department to select at least one vendor for placing orders and enables the selected vendor to submit data required by the personnel of one or more department to collaborate data or for procurement.

### BACKGROUND OF THE INVENTION

### A. Technical Field

The present invention generally relates to cloud-based requisition, procurement and data collaboration system and method, and more specifically relates to a cloud-based systems and methods for directly connecting engineering, operations, maintenance, construction, project management, service provider companies, enterprise and vendors and contractors in industrial applications for requisition, procurement of products and collaborating data, using common algorithms and Artificial Intelligence (AI).

### B. Description of Related Art

Requisition and Procurement of equipment, engineering, operations, maintenance, construction, project management, service provider companies, enterprise parts or components and data collaboration to/from vendors and contractors is a time-consuming and labor-intensive process. General method involves, interfacing the software suites used by engineering or operations or maintenance or construction or project management data with purchasing and procurement department or to collaborate data or to send the information to vendors or contractors to create inquiries, perform related calculations, quotes and finally the purchase orders. Referring to FIG. 1, conventional procurement process 100 is detailly explained as follows. At step 102, the project starts with client's initiation. At step 104, personnel of the engineering department or operations or maintenance or construction or project management or service provider companies or enterprise create a deliverable in a software suite in the form of data or document.

For example, engineering department or operations or maintenance or construction or project management or service provider companies or enterprise comprising instrument or process or mechanical or any other engineers or operators or maintenance or buyers, needs many Instrumentation and Control parts and equipment's or services from many different vendors or contactors. This work involves using one of the many suites of software available such as SmartPlant to enter the data into the specification sheets or datasheets by I&C and Process or Mechanical or any other engineers, or operators or maintenance or buyers. For Oil and Gas instance, the data includes process data, pipe numbers, Piping & Instrument Diagram numbers.

At step 106, personnel of procurement department or service providing companies or enterprise receives the files from the engineering department or operations or maintenance or construction or project management or service provider companies or enterprise in one of many formats available such as Words, PDF or Excels and creates the request for quote for parts or services. Then the drawings and data sheets are sent to at least three or four vendors or contractors. At step 108, the vendor or contractor receives the request for quote along with drawings in one or more of many document formats such as PDF or Excel. At step 110, the vendor or contractor need to change the format of document and drawings in order to be able to upload them into their software to perform their side of engineering and design and calculations.

At step 112, then the vendor or contractor creates a bid along with data and documents in a different proprietary or common format. At step 114, the procurement department receives the bids and send them to the engineering department or operations or maintenance or construction or project management for review. At step 116, the engineering department or operations or maintenance or construction or project management receives the bids in one of many different formats. Further, the engineering department or operations or maintenance or construction or project management reviews the bids and creates bid tabs.

At step 118, questions would be forwarded to selected vendor or vendors or contractors. At step 120, the selected vendor or contractor receives the questions and creates new documents to address the questions. At step 122, the engineering department or operations or maintenance or construction or project management receives the data or documents. At step 124, the personnel of the engineering departments or operations or maintenance or construction or project management provide a decision to purchase of the product. If the engineering departments or operations or maintenance or construction or project management rejects the proposal of the vendor, then the vendor would perform changes to satisfy the engineering or operations or maintenance or construction or project management personnel (step 126).

If the engineering departments or operations or maintenance or construction or project management accepts the proposal of the vendor, the procurement department performs the steps to purchase the equipment or services and the data, documents and materials are shipped to the client (step 128 and 130). At step 132, the process ends. As described above, the client and vendor may need to communicate frequently until the requirements are met by both parties. As a result, the procurement or ordering cycle may last from days to weeks or even more.

Currently industry lacks connectivity software or tools that could collaborate engineering or operations or maintenance or construction or project management with the vendors and/or contractors. Emerging technology such as Cloud computing aims to utilize applications, services and data in a main server farms in contrast to desktop computing. The server farms are remotely located and are implemented as a service. The centralized computing offers many benefits such as on-the-go connectivity and multiple platform execution with secure centrally managed data.

Henceforth, there is a need for a cloud-based system and methods to directly collaborate engineering personnel or operations or maintenance or construction or project management and vendors for procurement of products via a cloud platform utilizing common programming algorithms and artificial intelligence. Further, there is a need for a system and method that converts engineering or operations or maintenance or construction or project management data and documents into accessible data for purchase orders.

### SUMMARY OF THE INVENTION

The disclosure provides a system and method for using cloud computing to connect engineering, or operations or maintenance or construction or project management procurement, service providing companies and vendors and contractors for data collaboration or for designing and procurement process of parts and equipment and any related items for engineering, or operations or maintenance or construction or project management of plants or any industries.

In one embodiment, the present invention comprises a first user device associated with a first user, a second user device associated with a second user, a computing cloud with at least one data storage unit and at least one processing unit, at least one database in communication with the computing cloud and a network. In an embodiment, the first user device and the second user device are enabled to access the computing cloud via the network for sharing data and procurement of products or services from vendors or contractors directly by the personnel from an engineering department or operations or maintenance or construction or project management. In one embodiment, the first user is the personnel of an engineering department or operations or maintenance or construction or project management. In one embodiment, the second user is a vendor, company, enterprise, contractor or any of the first users.

The storage unit comprises a set of program modules comprises a data extraction module, a data gathering module, a vendor module, a product selection module, an order creation module, an order placement module and an order fulfillment module. The data extraction module, executed by the processor, is configured to extract data concerning an engineering design or operations or maintenance or construction or project management requirement from a computerized application. In an embodiment, the computerized application could be AutoCad, CADWORX, SmartPlant suite of products, Bentley Suites and many others. The data gathering module, executed by the processor, configured to upload the extracted data in the database for access by one or more second user.

The vendor module, executed by the processor, configured to enable one or more second users to access the uploaded data and generate quotation related documents after performing their calculations and other requirements. The product selection module, executed by the processor, configured to create a bid evaluation including a list of one or more second user comprising one or more products matching the engineering design, utilizing common algorithms and Artificial Intelligence (AI) platforms hosted in the computing cloud. The order creation module, executed by the processor, configured to enable the first user to evaluate said one or more matching product and create a purchase request for at least one selected product. The order placement module, executed by the processor, configured to send the purchase request to a second user of the selected product for further proceedings. The order fulfillment module, executed by the processor, configured to enable the selected second user to complete the purchase request by filling and forwarding documents that are required by the first user.

In one embodiment, a cloud-based method for directly collaborating engineering personnel or operations or maintenance or construction or project management within the enterprise or company and vendors for data collaboration, requisition and procurement of products is illustrated. In one embodiment, the method is incorporated in the system comprising a computing cloud with a processor and a storage unit, a database in communication with the server for storing plurality of engineering design or operations or maintenance or construction or project management data and vendor product data, a first user device and a second user device configured to access the computing cloud via a network. At one step, the method includes, extracting at the cloud or processor, via a data extraction module, data concerning an engineering design from a computerized application.

At one step, the method includes, uploading at the cloud or processor, via a data gathering module, the extracted data in the database for access by one or more second user. At one step, the method includes, enabling at the processor, via a vendor module, one or more second user to access the uploaded data and generate collaborative data, requisitions or quotation and related documents. At one step, the method includes, creating at the cloud processor, via a product selection module, a bid evaluation including a list of one or more second user comprising one or more products matching the engineering design, utilizing common programming algorithms or Artificial Intelligence platforms hosted in the computing cloud. At one step, the method includes, enabling at the cloud or processor, via an order creation module, the first user to evaluate said one or more matching product and create a purchase request for at least one selected product. At one step, the method includes, sending, at the cloud or processor, via an order placement module, the purchase request to a second user of the selected product for further proceedings. At one step, the method includes, enabling, at the cloud or processor, via an order fulfillment module, the selected second user to complete the purchase request by filling and forwarding documents that are required by the first user.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

The embodiments herein will be better understood from the following detailed description with reference to the drawings, in which:

FIG. 1 is a prior art illustrating a conventional procurement process.

FIG. 2 exemplarily illustrates an environment implemented in accordance with various embodiments of the invention.

FIG. 3 exemplarily illustrates a block diagram of a computing cloud server, according to an embodiment of the present invention.

FIG. 4 exemplarily illustrates a flowchart for directly collaborating engineering personnel and vendors for procurement of products via a cloud platform utilizing Artificial Intelligence, according to an embodiment of the present invention.

FIG. 5 exemplarily illustrates a detailed flowchart for collaborating engineering, or operations or maintenance or construction or project management and vendors and contractors in industrial applications for procurement of products or services, according to an embodiment of the present invention.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

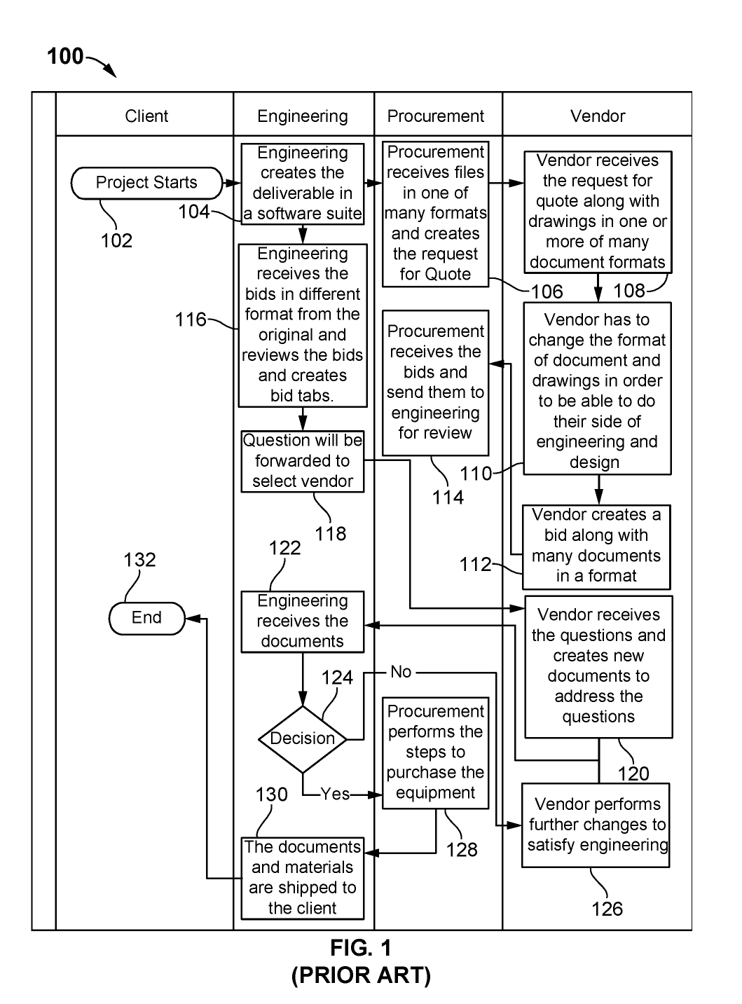

The present invention discloses a cloud-based system and methods for directly collaborating engineering personnel or operations or maintenance or construction or project management and vendors and contractors for collaborating data or procurement of products or services via a cloud platform utilizing common programming algorithms or artificial intelligence. The system is configured to store and mange engineering design data developed by multitude of software. The system enables different teams or one or more vendors to access the engineering design or operations or maintenance or construction or project management data for collaborating data or generating requisition, quote or related documents. The system further enables the personnel of engineering department or operations or maintenance or construction or project management for collaborating data or to place orders and enables the selected vendor to submit documents required by the personnel of the engineering department or operations or maintenance or construction or project management via the cloud platform. Referring to FIG. 1, a block diagram of an environment 200 implemented in accordance with various embodiments of the present invention is disclosed. The environment 200 comprises a first user device 202, a network 204, a cloud-based system 206 and a second user device 211. In an embodiment, the system 206 comprises a computing cloud server 208 and at least one database 210.

In an embodiment, the first user device 202 and the second user device 211 is enabled to access the cloud-based system 206 via the network 204 for collaborating data or procurement of products from vendors directly by the personnel from an engineering department or operations or maintenance or construction or project management. In one embodiment, the first user could be personnel of an engineering or operations or maintenance or construction or project management, or a buyer. In one embodiment, the second user could be a contractor, company, enterprise, vendor or the first user. The computing cloud 208 is configured to store and mange engineering design or operations or maintenance or construction or project management data developed by multitude of software and enables one or more vendors to access the engineering design or operations or maintenance or construction or project management data. In an embodiment, the first user device 202 is at least one of a desktop, a laptop, a tablet, a mobile phone, and mobile and/or handheld electronic devices. In an embodiment, the second user device 211 is at least one of a desktop, a laptop, a tablet, a mobile phone, and mobile and/or handheld electronic devices. In an embodiment, the network 204 could be Wi-Fi network, WiMax network, and wireless local area network.

In one embodiment, the at least one database 210 may be accessible by the computing cloud server 208. The database 210 may be integrated into the computing cloud server 108 or separate from it. In some embodiments, the database 210 resides in a connected server or in a cloud computing service. Regardless of location, the database 210 comprise memory to store and organize certain data for use by the computing cloud 208. In some embodiments, the database stores plurality of engineering or operations or maintenance or construction or project management data or documents, vendor data, vendor product data or database.

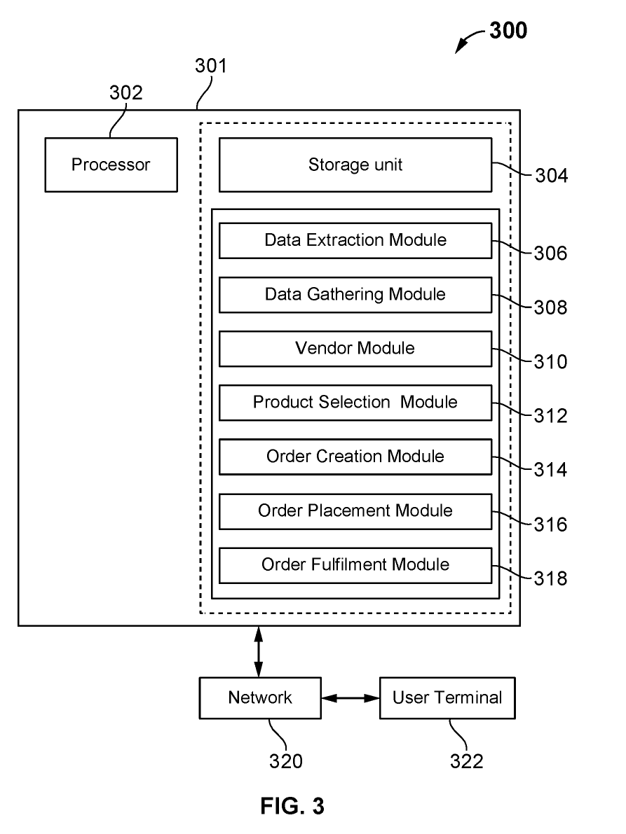

In one embodiment, the computing cloud 208 is at least one of a general or special purpose computer or server. The computing cloud 208 could be operated as a single computer, which can be a hardware and/or software server, a workstation, a desktop, a laptop, a tablet, a mobile phone, a mainframe, a supercomputer, a server farm, and so forth. In some embodiments, the computer could be touchscreen and/or non-touchscreen and adopted to run on any type of OS, such as iOS™, Windows™, Android™, Unix™ Linux™ and/or others. In one embodiment, the plurality of computers is in communication with each other, via networks. Such communication can be via a software application, a mobile app, a browser, an OS, and/or any combination thereof. Further, a block diagram 300 of an exemplary implementation of the computing cloud server (208 or 301) is illustrated in FIG. 3.

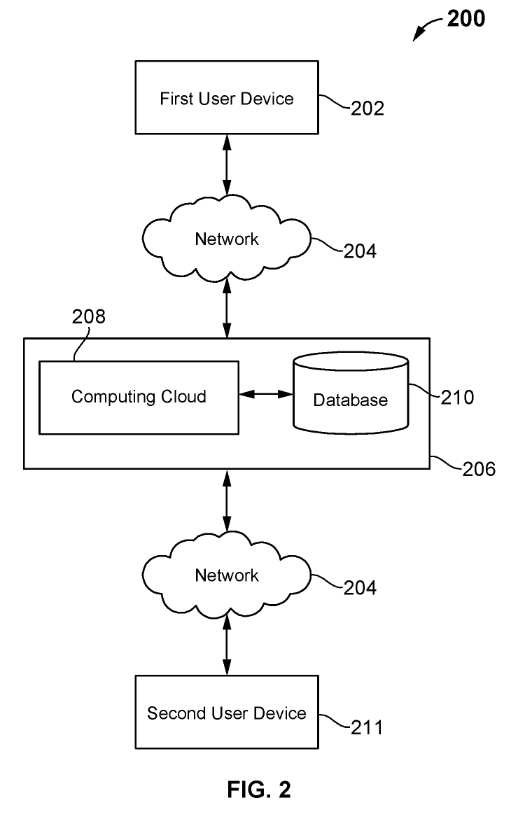

FIG. 2 is a block diagram 200 of the computing cloud server 301 in an embodiment of the present invention. The server 301 comprises a processor 302 and a storage unit 304. The storage unit 304 comprises a set of program modules comprises a data extraction module 306, a data gathering module 308, a vendor module 310, a product selection module 312, an order creation module 314, an order placement module 316 and an order fulfillment module 318. In one embodiment, the user access server 301 via a user terminal 322 via a network 320. In some embodiments, the network 320 is at least anyone of a Wi-Fi network, WiMax network, and wireless local area network. In some embodiments, the user terminal 322 is at least anyone of a desktop, a laptop, a tablet, a mobile phone, mobile and/or handheld electronic devices, personnel digital assistants, smart phones, smart televisions, palm tops and phablets.

In one embodiment, the server 202 is configured to directly collaborate data among engineering or operations or maintenance or construction or project management personnel and/or vendors for collaborating data and/or to vendors for procurement of products. The data extraction module 306, executed by the processor 204, is configured to extract data concerning an engineering design or operations or maintenance or construction or project management from a computerized application or software. In an embodiment, the computerized application could be AutoCad, CADWORX, SmartPlant suite of products, Bentley Suites or other computerized application utilized in engineering or operations or maintenance or construction or project management. The data gathering module 308, executed by the processor 204, configured to upload the extracted data in the database for access by one or more second user.

The vendor module 310, executed by the processor 204, configured to enable one or more second user to access the uploaded data and for collaborating data and/or to perform calculations and/or generate quotation or related documents. The product selection module 312, executed by the processor 204, configured to create a bid evaluation including a list of one or more second user comprising one or more products matching the engineering design, utilizing common programming algorithms or an Artificial Intelligence platform hosted in the computing cloud. The order creation module 314, executed by the processor 204, configured to enable the first user to evaluate said one or more matching product and create a purchase request for at least one selected product. The order placement module 316, executed by the processor 204, configured to send the purchase request to a second user of the selected product for further proceedings. The order fulfillment module 318, executed by the processor 204, configured to enable the selected second user to complete the purchase request by filling and forwarding documents that are required by the first user.

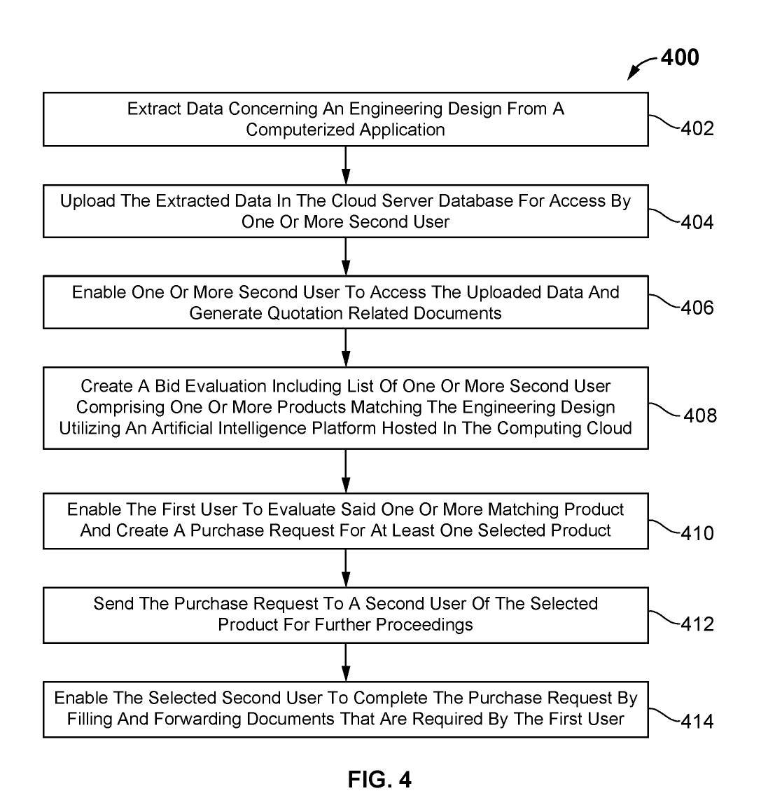

Referring to FIG. 4, a cloud-based method 400 for directly collaborating data among engineering or operations or maintenance or construction or project management personnel and/or vendors for collaborating data and/or procurement of products is illustrated. In one embodiment, the method 400 is incorporated in the system comprising a computing cloud with a processor and a storage unit, a database in communication with the server for storing plurality of engineering design data and vendor product data and a first user device and a second user device configured to access the computing cloud via a network. At step 402, the method 400 includes, extracting at the processor, via a data extraction module, data concerning an engineering design from a computerized application.

At step 404, the method 400 includes, uploading at the processor, via a data gathering module, the extracted data in the database for access by one or more second user. At step 406, the method 400 includes, enabling at the processor, via a vendor module, one or more second user to access the uploaded data for collaborating data and/or generate quotation related documents. At step 408, the method 400 includes, creating at the processor, via a product selection module, a bid evaluation including a list of one or more second user comprising one or more products matching the or operations or maintenance or construction or project management design, utilizing common programming algorithms or an Artificial Intelligence platform hosted in the computing cloud. At step 410, the method 400 includes, enabling at the processor, via an order creation module, the first user to evaluate said one or more matching product and create a purchase request for at least one selected product. At step 412, the method 400 includes, sending, at the processor, via an order placement module, the purchase request to a second user of the selected product for further proceedings. At step 414, the method 400 includes, enabling, at the processor, via an order fulfillment module, the selected second user to complete the purchase request by filling and forwarding documents that are required by the first user.

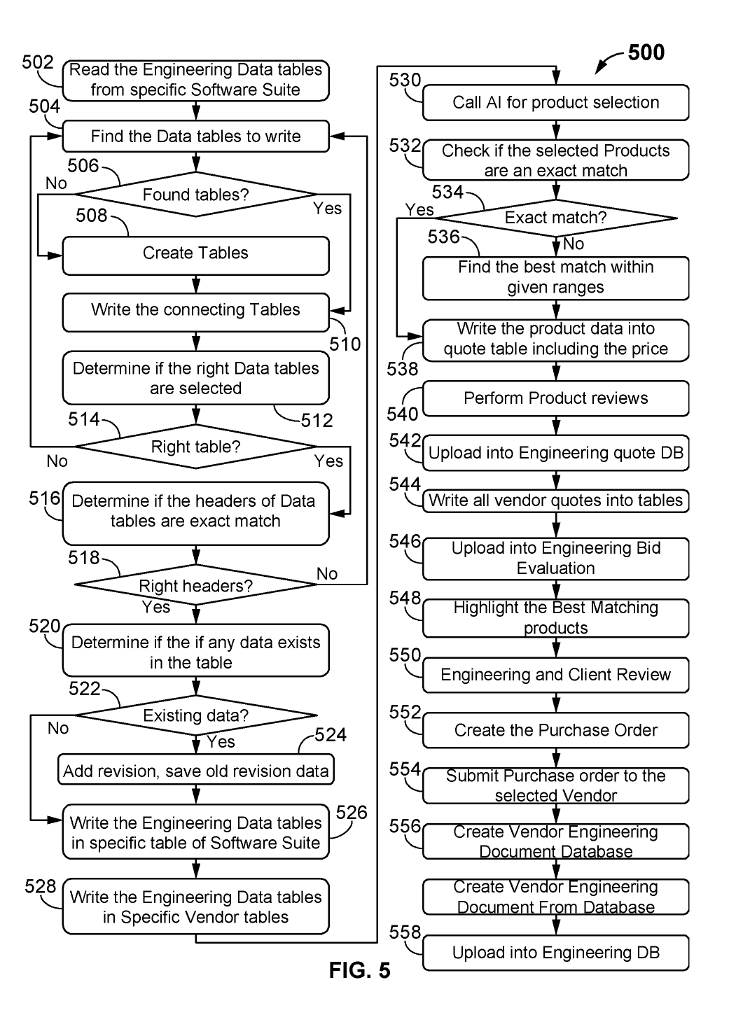

Referring to FIG. 5, a detailed process 500 of the system for directly collaborating engineering or operations or maintenance or construction or project management personnel and vendors for collaborating data and/or procurement of products is disclosed. At step 502, the engineering or operations or maintenance or construction or project management design or data from a specific software used for designing or operations or maintenance or construction or project management is extracted. At step 504, the system is configured to find tables to write the extracted data. At step 506, the system determines if the tables were found. At step 508, if the tables are not found, new tables are created to write the extracted data. At step 510, the extracted data is added in the existing tables, if tables are found at step 506.

At step 512, the computing cloud determines if a right data tables were selected. At step 514, if right tables are not determined, the process returns to step 504. At step 516, if right tables are determined, the computing cloud is configured to determine a header of the data tables are exact match. At step 518, if the headers do not match the data tables, the process returns to 504. At step 520, if the headers are exact match, the computing cloud is configured to determine whether any old data exists in the table. If the data table does not comprise any existing data (at step 522), the computing cloud is configured to write engineering or operations or maintenance or construction or project management data tables in the specific table of software suite (at step 524). At step 526, if the data table comprises any existing data or old data, the computing cloud is configured to save a file of old data as a backup and, then adds revision to the existing data.

At step 528, the computing cloud is configured to write the engineering or operations or maintenance or construction or project management data tables in specific vendor or contractor or engineering or operations or maintenance or construction or project management tables. At step 530, the computing cloud utilizes common programming algorithms or artificial intelligence for product selection. At step 532, the computing cloud is configured to check if the selected products are exact match. At step 534, the system identifies if the products are exact match. At step 536, the computing cloud is configured to find best match within given ranges if selected products are not exact match. At step 538, the computing cloud is configured to write the product data into engineering or operations or maintenance or construction or project management or a quote table on exact or the closest match of the selected product. At step 540, the computing cloud is configured to perform product reviews. At step 542, the computing cloud is configured to upload product reviews into an engineering quote database or document. At step 544, the computing cloud is configured to input all vendor quotes into the engineering or operations or maintenance or construction or project management data tables.

At step 546, the computing cloud is configured to upload into engineering or operations or maintenance or construction or project management bid evaluation data. At step 548, the computing cloud is configured to highlight the best matching products. At step 550, the computing cloud is configured to allows an engineering or operations or maintenance or construction or project management personnel of an engineering or operations or maintenance or construction or project management department to review the bid evaluation data and best matching products. At step 552, the computing cloud is configured to enable the engineering or operations or maintenance or construction or project management personnel to create the purchase order.

At step 554, the computing cloud is configured to create vendor engineering or operations or maintenance or construction or project management documents and/or database. At step 556, the computing cloud is configured to create vendor engineering or operations or maintenance or construction or project management documents from database. At step 558, the computing cloud is configured to upload the vendor engineering or operations or maintenance or construction or project management documents into an engineering or operations or maintenance or construction or project management database.

Advantageously, the present invention connects engineering or operations or maintenance or construction or project management department directly within the enterprise or company and/or to vendors and vice versa; connects computing cloud with engineering or operations or maintenance or construction or project management software such as SmartPlant and AutoCad and any engineering or operations or maintenance or construction or project management or vendors and contractors; reduces the man-hour spent by the engineering or operations or maintenance or construction or project management department, contactors, vendors by up to 30%; eliminates the errors in traditional procurement methods; automatically finds the best solution for the request placed by engineering or operations or maintenance or construction or project management department and transfers the product data to engineering or operations or maintenance or construction or project management department once reviewed by the vendor, and provides a multi-platform application with extensions that enables to connect with specific software suite of products within the enterprise or company and/or to vendors and vice versa.

The present invention further reduces the time taken for collaborating data and/or to place purchase orders; supports and automates engineering or operations or maintenance or construction or project management or buyer's daily responsibilities and therefore reduces the likelihood of losing or misplacing documents such as drawings and purchase orders; utilizes the common programming algorithms or artificial intelligence for data collaboration and/or for product selection, and filling in forms and other required documents that are a necessary part of every engineering or operations or maintenance or construction or project management and/or procurement activity; creates a bid evaluation that lists the requirements versus vendor's solution and highlights the best fit(s); enables the engineers or operations or maintenance or construction or project management for collaborating data and/or to place orders automatically on selecting the best fit product, and enables vendor to automatically receive a purchase request on selecting the best fit product.

Although a single embodiment of the invention has been illustrated in the accompanying drawings and described in the above detailed description, it will be understood that the invention is not limited to the embodiment developed herein, but is capable of numerous rearrangements, modifications, substitutions of parts and elements without departing from the spirit and scope of the invention.

The foregoing description comprises illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein.

What is claimed is:

1. A cloud-based system for collaborating activities of one or more department including engineering, operations, maintenance, construction, project management, procurement, vendor and contractor, comprising:
a computing cloud comprising,
at least one data storage device, and
at least one processing device, wherein the computing cloud is configured to provide shared services to one or more department including industrial, construction, procurement, contractors, operations and maintenance to automate procedures and collaborate data;
a database in communication with the server;
a first user device associated with a first user to access the computing cloud via a network; and
a second user device associated with a second user to access the computing cloud via the network,
wherein at least one data storage device stores a set of program modules, and
wherein at least one processing device in communication with at least one data storage device, configured to execute the set of program modules, wherein the set of program modules comprises,
a data extraction module configured to extract data concerning one or more activities of one or more department including engineering design, operations, maintenance, construction and project management from a computerized application,
a data gathering module configured to upload the extracted data in the database for access by one or more second user,
a vendor module configured to enable one or more second user to access the uploaded data for executing at least one operation including collaboration, perform calculations, generate quotation related database and documents,
a product selection module configured to select products and create a bid evaluation including a list of one or more second user comprising one or more products matching the uploaded data, utilizing common programming algorithms or an Artificial Intelligence (AI) platform hosted in the computing cloud,
an order creation module configured to enable the first user to evaluate said one or more matching product and create a purchase request for at least one selected product,
an order placement module configured to send the purchase request to a second user of the selected product for further proceedings, and
an order fulfillment module configured to enable the selected second user to complete the purchase request by filling the database tables and forwarding data base and documents that are required by the first user.

2. The system of claim 1, wherein the first user device is at least one of a tablet computer, personnel computer, personnel digital assistant, smart phone, smart television, palm top, phablet, laptop, or a device with computational capability connected to the internet.

3. The system of claim 1, wherein the second user device is at least one of a tablet computer, personnel computer, personnel digital assistant, smart phone, smart television, palm top, phablet, laptop, or a device with computational capability connected to the internet.

4. The system of claim 1, wherein the first user is personnel from at least anyone of the department including engineering, operation, maintenance, construction, and project management department or a buyer.

5. The system of claim 1, wherein the second user is at least one of a vendor, engineering, maintenance, construction, project management and contractor.

6. The method of claim 1, wherein the second user is an enterprise or a company.

7. The system of claim 1, wherein the storage unit is at least one of a volatile memory, non-volatile memory, read only memory (ROM), random access memory (RAM), a flash memory and cloud.

8. The system of claim 1, wherein the network is at least one of a Local Area Network, a Wide Area Network, a Wireless Network, a telecommunication network, a mobile network, and an Internet or cloud.

9. A cloud-based method for collaborating activities of one or more department including engineering, operations, maintenance, construction, project management, procurement, vendor and contractor, incorporated in the system comprising a computing cloud with a processor and a storage unit, a database in communication with the server for storing plurality of engineering design, maintenance, construction, project management data and vendor product data, a first user device and a second user device configured to access the computing cloud via a network, comprising the steps of:
extracting at the processor, via a data extraction module, data concerning one or more activities of one or more department including engineering design, operations, maintenance, construction and project management from a computerized application;
uploading at the processor, via a data gathering module, the extracted data in the database for access by one or more second user;
enabling at the processor, via a vendor module, one or more second user to access the uploaded data for executing at least one operation including collaboration, perform calculations, generate quotation related database and related documents;
creating at the processor, via a product selection module, a bid evaluation including a list of one or more second user comprising one or more products matching the uploaded data, utilizing common programming algorithms or an Artificial Intelligence platform hosted in the computing cloud;
enabling at the processor, via an order creation module, the first user to evaluate said one or more matching product and create a purchase request for at least one selected product;
sending, at the processor, via an order placement module, the purchase request to a second user of the selected product for further proceedings, and
enabling, at the processor, via an order fulfillment module, the selected second user to complete the purchase request by filling and forwarding documents that are required by the first user.

10. The method of claim 8, wherein the first user device is at least one of a tablet computer, personnel computer, personnel digital assistant, smart phone, smart television, palm top, phablet, laptop, or a device with computational capability connected to the internet.

11. The method of claim 8, wherein the second user device is at least one of a tablet computer, personnel computer, personnel digital assistant, smart phone, smart television, palm top, phablet, laptop, or a device with computational capability connected to the internet.

12. The method of claim 8, wherein the first user is personnel from at least anyone of the department including engineering, operation, maintenance, construction, and project management department or a buyer.

13. The method of claim 8, wherein the second user is at least one of a vendor, engineering, maintenance, construction, project management and contractor.

14. The method of claim 8, wherein the second user is an enterprise or a company.

15. The method of claim 8, wherein the storage unit is at least one of a volatile memory, non-volatile memory, read only memory (ROM), random access memory (RAM), a flash memory and a cloud.

16. The method of claim 8, wherein the network is at least one of a Local Area Network, a Wide Area Network, a Wireless Network, a telecommunication network, a mobile network, and an Internet or cloud.
